(19) United States
(12) Patent Application Publication
(10) Pub. No.: US 2008/0037991 A1
(43) Pub. Date: Feb. 14, 2008

(54) Optical wavelength multiplex transmission apparatus, control method thereof and optical wavelength multiplex transmission system

(75) Inventors: Katsumi Sugawa, Fukuoka (JP); Takeshi Noma, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/889,190

(22) Filed: Aug. 9, 2007

(30) Foreign Application Priority Data
Aug. 10, 2006 (JP) JP2006-218405

(51) Int. Cl. H04J 14/02

(52) U.S. Cl. 398/97

(57) ABSTRACT

An optical wavelength multiplex transmission apparatus includes a demultiplexer (12) that divides a wavelength-multiplexed optical signal into optical signals of individual wavelengths, an optical attenuation control portion (13) that performs an optical attenuation control so that levels of the optical signals of individual wavelengths become constant, a multiplexer (16) that combines the optical signals of individual wavelengths after the optical attenuation control and multiplexes them, an optical signal level storing portion (15) that stores a first level range of optical signal levels, and an optical attenuation control stopping portion (22) that decides whether or not a level of each of the optical signals of individual wavelengths is within the first level range obtained from the optical signal level storing portion (15), and if its level is within the first level range, stops the optical attenuation control for an optical signal of a wavelength having the level.

### BACKGROUND OF THE INVENTION

1. Field of the Invention

The present invention relates to an optical wavelength multiplex transmission apparatus that performs optical attenuation control so that an optical signal has a constant level at each wavelength in a wavelength-multiplexed signal, a control method of the apparatus, and an optical wavelength multiplex transmission system. In particular, the present invention relates to a control method for suppressing accumulation of fluctuations in an optical signal level when the optical wavelength multiplex transmission apparatuses are connected in a multistage form.

2. Description of the Prior Art

Conventionally, a wavelength division multiplexing (WDM) method is often used as a large capacity and high speed transmission method in an optical network (see Japanese unexamined patent publications No. 2000-4213 and No. 2003-234702). As to the optical transmission system of the wavelength division multiplexing method (hereinafter referred to also as a “WDM system”), it is necessary to maintain optical signal levels (optical levels) of individual wavelength channels of a multiplexed signal to a uniform and optimal value in order to ensure its transmission quality. Therefore, an optical attenuation control (VAT control) is performed conventionally for making the optical signal levels of individual wavelengths be a constant value.

FIG. 11 is a diagram showing a conventional structure of a general WDM system 80.

In FIG. 11, the WDM system 80 is made up of a plurality of nodes ND11, ND12, ND13 and so on connected in a multistage form. Each node ND is provided with a demultiplexer 81 that divides a wavelength-multiplexed optical signal into optical signals of individual wavelengths, an optical attenuation control portion 82 that performs optical attenuation control so that optical signal levels of individual wavelengths become a constant value, and a multiplexer 83 that combines and multiplexes the optical signals of individual wavelengths after the optical attenuation control. Note that amplifiers are disposed before the demultiplexer 81 and after the multiplexer 83.

Incident light that enters each node ND from a client side is divided by each demultiplexer 81, and the optical attenuation control portion 82 performs the optical attenuation control for each wavelength of light so that optical signal levels of individual wavelengths become a constant value. Then, they are combined by the multiplexer 83 and sent to a transmission line (WDM transmission line) KS.

In the conventional system structure as described above, fluctuations in the optical signal level may be generated in the case where the nodes ND are connected in a multistage form. More specifically, the optical attenuation control portion 82 of each node ND in the conventional structure performed the optical attenuation control by using the same control time. Therefore, as the number of stages of the nodes ND increases, minute fluctuations in the optical signal level are accumulated from the first node, which becomes extent that cannot be ignored and affects badly to a main signal.

A mechanism of accumulating the fluctuations in the optical signal level is considered as follows. There is a delay element as the control time in the optical attenuation control portion 82. The optical attenuation control portion 82 is supplied with optical signals having various frequencies due to various factors. If an optical signal S11 having a period that is twice the control time is supplied as shown in FIG. 12, the control for suppressing fluctuations will reduce the amplitude by the length of the arrow P5 in the direction of the arrow P5 at the time point TA. However, because of a control delay due to the control time, the effect of the control appears at the time point TAA that is late from the time point TA by the control time. Therefore, the optical signal S11 at the time point TAA is altered from an input level of the optical signal S11 by the arrow P6 that has the same direction and length as the arrow P5, so that amplitude of an output optical signal S12 increases with respect to that of the input optical signal S11. The output optical signal S12 becomes the input optical signal S11 of the next node ND, and the optical signal S12 thereof will also have increased amplitude by the same process. This accumulation of processes increases fluctuations in the optical signal as shown in FIG. 13. As the stages of the nodes ND increase, amplitude of the fluctuations increases and affects badly more to the main signal.

Therefore, the conventional structure has a problem that it takes time until the optical signal level becomes stable in the optical attenuation control. Further, there is another problem that the number of nodes that can be connected is limited.

### SUMMARY OF THE INVENTION

An object of the present invention is to eliminate the defect of the conventional optical attenuation control that is the accumulation of fluctuations in the optical signal level and to suppress the accumulation of the fluctuations in the optical signal level even if the nodes are connected in a multistage form.

A method according to one aspect of the present invention is a control method of an optical wavelength multiplex transmission apparatus that performs an optical attenuation control so that a level of an optical signal becomes constant in each wavelength-multiplexed wavelength. The method includes the steps of deciding whether or not each level of optical signal of each wavelength is within a predetermined first level range, and if its level is within the first level range, stopping the optical attenuation control for an optical signal of a wavelength having the level.

Preferably, the method further may include the steps of deciding whether or not the level of the optical signal of the wavelength for which the optical attenuation control is stopped is within a predetermined second level range, and restarting the optical attenuation control of the optical signal if its level is not within the second level range.

An apparatus according to another aspect of the present invention includes a demultiplexer that divides a wavelength-multiplexed optical signal into optical signals of individual wavelengths, an optical attenuation control portion that performs an optical attenuation control so that levels of the optical signals of individual wavelengths become constant, a multiplexer that combines the optical signals of individual wavelengths after the optical attenuation control and multiplexes them, an optical signal level storing portion that stores a first level range of optical signal levels,.and an optical attenuation control stopping portion that decides whether or not a level of each of the optical signals of individual wavelengths is within the first level range obtained from the optical signal level storing portion, and if its level is within the first level range, stops the optical attenuation control for an optical signal of a wavelength having the level.

Preferably, the optical signal level storing portion may store a plurality of first level ranges in accordance with a node position of the optical wavelength multiplex transmission apparatus in a network, and the optical attenuation control stopping portion may perform the decision by using the first level range that is obtained in correspondence to a node position of the optical wavelength multiplex transmission apparatus among the plurality of first level ranges stored in the optical signal level storing portion.

A system according to yet another aspect of the present invention is an optical wavelength multiplex transmission system in which an optical wavelength multiplex transmission apparatus is disposed at a node of a network. The optical wavelength multiplex transmission apparatus includes a demultiplexer that divides a wavelength-multiplexed optical signal into optical signals of individual wavelengths, an optical attenuation control portion that performs an optical attenuation control so that levels of the optical signals of individual wavelengths become constant, a multiplexer that combines the optical signals of individual wavelengths after the optical attenuation control and multiplexes them, an optical signal level storing portion that stores a plurality of first level ranges of optical signal levels in accordance with a function of the optical wavelength multiplex transmission apparatus at a node in the network, a first level range obtaining portion that obtains a first level range, among the plurality of first level ranges stored in the optical signal level storing portion, which corresponds to an instruction from an operational system that manages the optical wavelength multiplex transmission system, and an optical attenuation control stopping portion that decides whether or not a level of each of the optical signals of individual wavelengths is within the first level range obtained from the first level range obtaining portion, and if its level is within the first level range, stops the optical attenuation control for an optical signal of a wavelength having the level.

According to the present invention, the defect of the conventional optical attenuation control that is accumulation of fluctuations in the optical signal level can be eliminated, and the accumulation of fluctuations in the optical signal level can be suppressed even if nodes are connected in a multistage form.

### BRIEF DESCRIPTION OF THE DRAWINGS

FIG. 1 is a diagram showing a structure of a WDM system according to an embodiment of the present invention.

FIG. 2 is a block diagram showing a structure of an optical wavelength multiplex transmission apparatus.

FIG. 3 is a diagram for explaining a function of a main portion of the optical wavelength multiplex transmission apparatus.

FIG. 4 is a diagram for explaining optical attenuation control performed by the optical wavelength multiplex transmission apparatus.

FIG. 5 is a diagram showing an example of a level range stored in a level storing portion.

FIG. 6 is a timing chart showing a state of the optical attenuation control.

FIG. 7 is a timing chart showing a state of the optical attenuation control.

FIG. 8 is a diagram for explaining an effect of suppressing fluctuations in the optical signal level.

FIG. 9 is a flowchart showing a flow of the optical attenuation control.

FIG. 10 is a flowchart showing an example of a stop process.

FIG. 11 is a diagram showing a structure of a conventional and general WDM system.

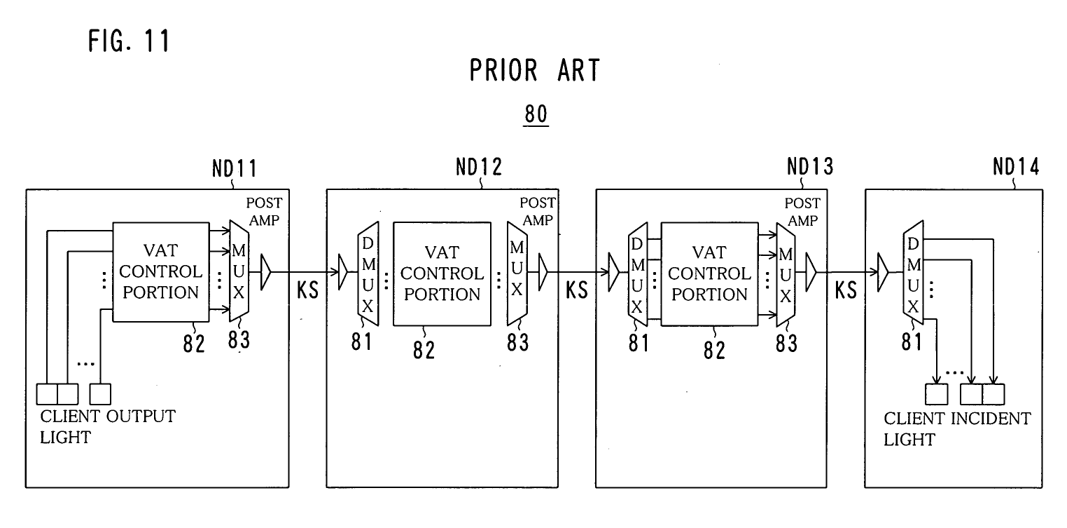

FIG. 12 is a diagram for explaining a mechanism of accumulating the fluctuations in the optical signal level.

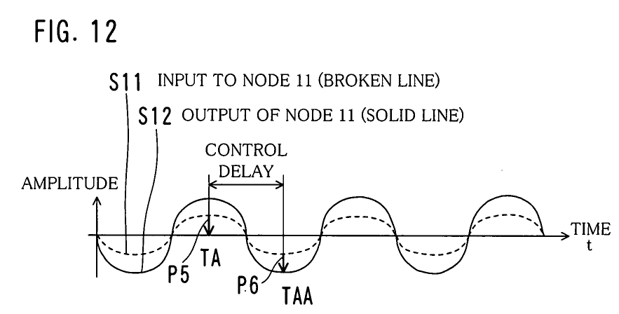

FIG. 13 is a diagram showing a state of accumulating the fluctuations in the optical signal.

### DESCRIPTION OF THE PREFERRED EMBODIMENTS

The invention will now be described in detail with reference to the attached drawings.

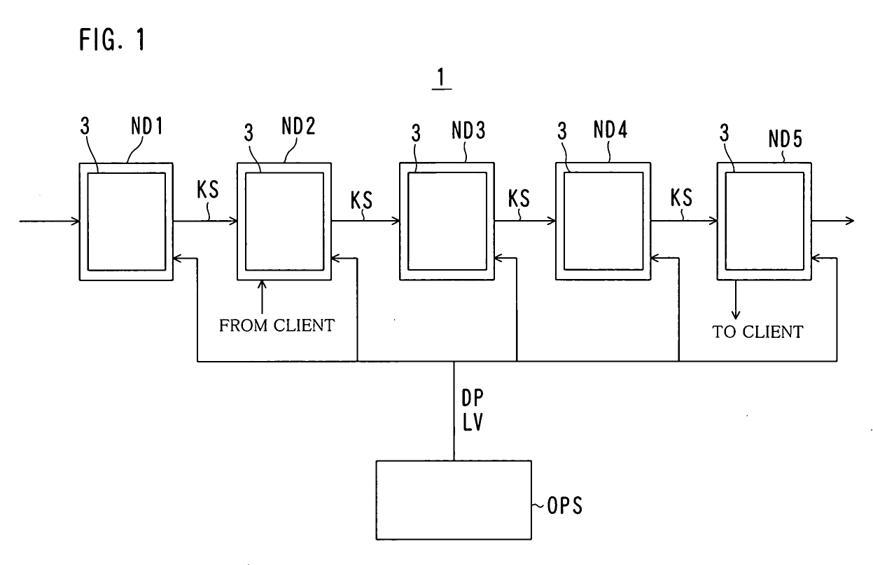

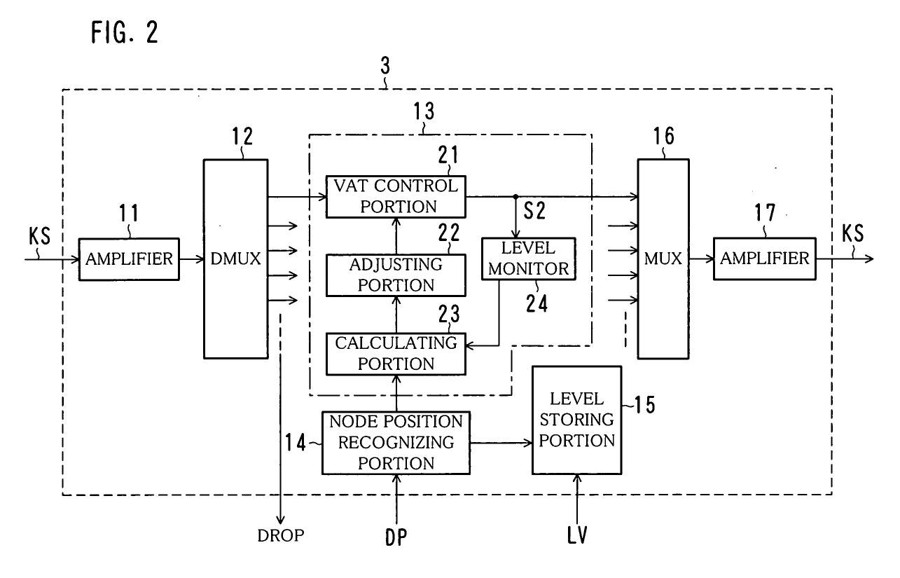

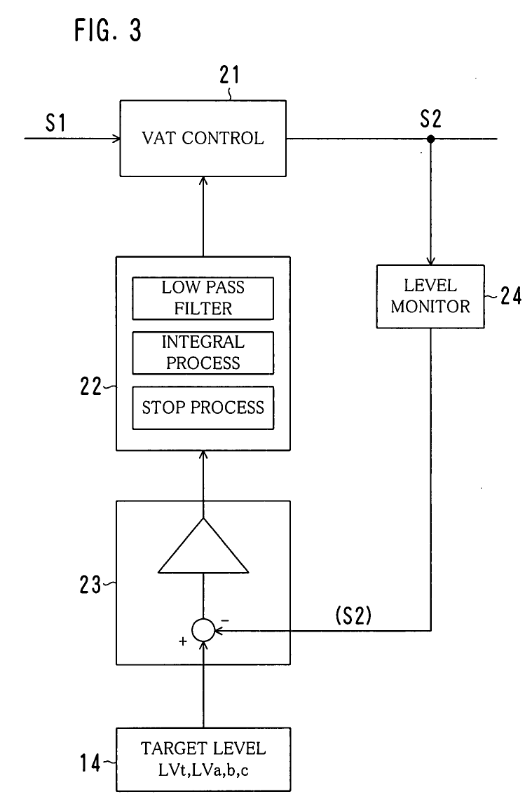

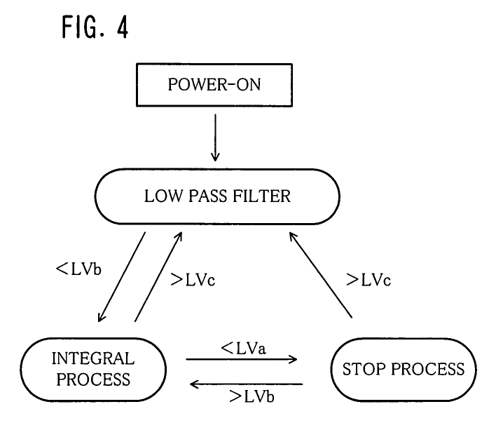

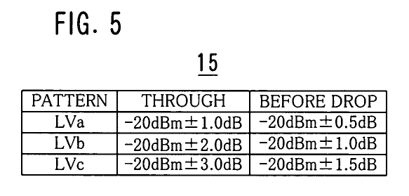

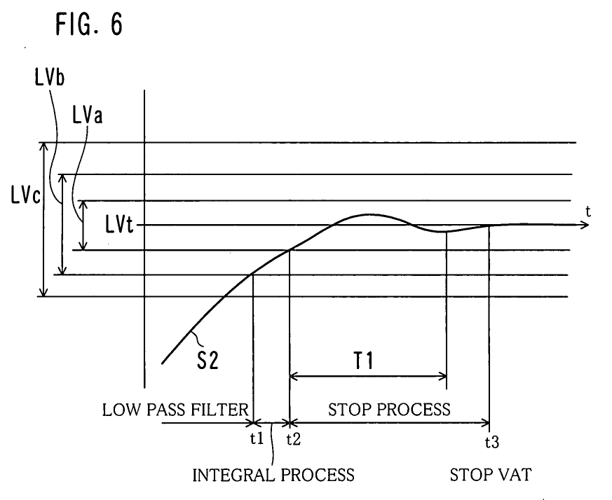

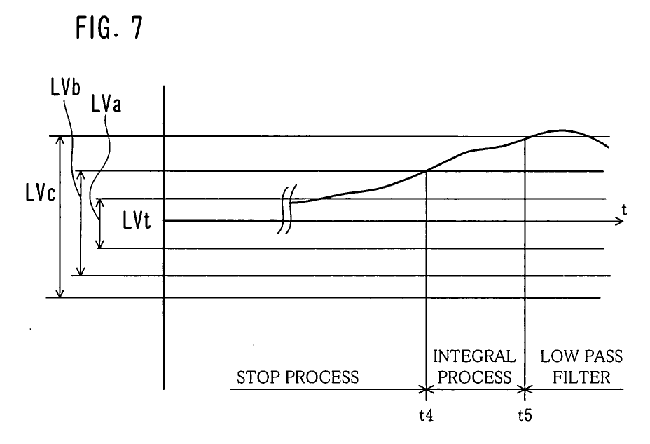

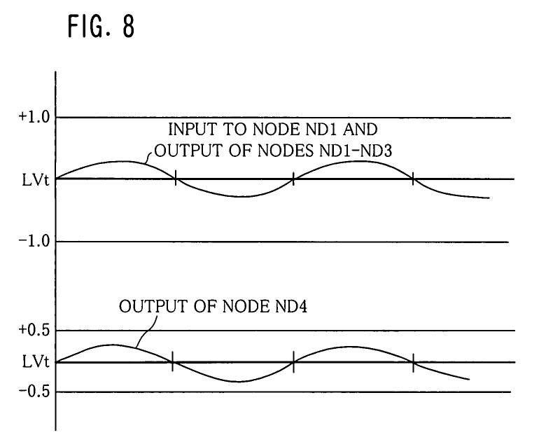

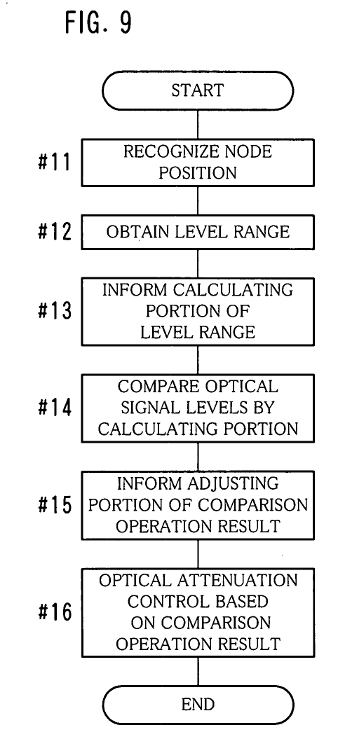

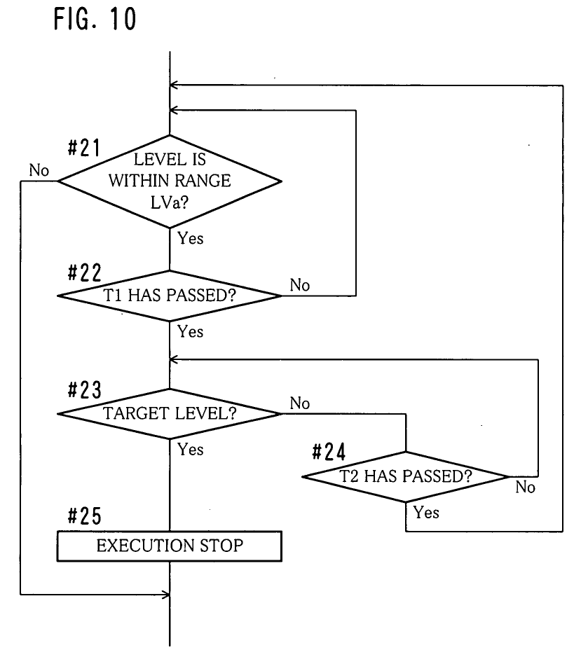

FIG. 1 is a diagram showing a structure of a WDM system 1 that uses an optical wavelength multiplex transmission apparatus 3 according to an embodiment of the present invention, FIG. 2 is a block diagram showing a structure of the optical wavelength multiplex transmission apparatus 3, FIG. 3 is a diagram for explaining functions of an adjusting portion and a calculating portion of the optical wavelength multiplex transmission apparatus 3, FIG. 4 is a diagram for explaining optical attenuation control (VAT control) performed by the optical wavelength multiplex transmission apparatus 3, FIG. 5 is a diagram showing an example of a level range stored in a level storing portion 15, FIG. 6 is a timing chart showing a state of the optical attenuation control, FIG. 7 is a timing chart showing a state of the optical attenuation control, FIG. 8 is a diagram for explaining an effect of suppressing fluctuations in the optical signal level by the optical attenuation control, FIG. 9 is a flowchart showing a flow of the optical attenuation control, and FIG. 10 is a flowchart showing an example of a stop process.

In FIG. 1, the WDM system 1 is made up of a plurality of nodes ND1, ND2, ND3 and so on connected in a multistage form via lines (transmission lines) KS, and optical signals after optical wavelength multiplex processes are transmitted. Each node ND is provided with an optical wavelength multiplex transmission apparatus 3, to which an optical signal is supplied from a client as necessity (add), from which an optical signal is delivered to a client as necessity (drop), or the optical signal is transmitted without an input from or an output to the client (through).

In the example shown in FIG. 1, the node ND2 is set to an “add node”, the node ND5 is set to a “drop node”, and other nodes ND1, ND3 and ND4 are set to a “through node”. Note that the first stage node ND may always be set to the add node, while the final stage node ND may always be set to the drop node in the WDM system 1 that is connected in a line style. Alternatively, the nodes ND may be connected in a ring style or a network style.

In order to control the individual nodes ND, there is disposed an operational station OPS. The operational station (operational system) OPS is provided with a computer for controlling use, which sends node position information DP to each node ND. In addition, it transmits a reference level LV that is used in each node ND for the optical attenuation control and performs other various setting that are necessary for each node ND to operate in an optimal condition, and it also monitors an operating state of each node ND. Each node ND performs the optical attenuation control as an independent and asynchronous operation and performs the stop process and the like.

In FIG. 2, the optical wavelength multiplex transmission apparatus 3 includes an amplifier 11, a demultiplexer 12, an optical attenuation control portion 13, a node position recognizing portion 14, a level storing portion 15, a multiplexer 16 and an amplifier 17.

The amplifier 11 amplifies a wavelength-multiplexed optical signal that is supplied from the preceding optical wavelength multiplex transmission apparatus 3. The demultiplexer 12 divides (separates) the wavelength-multiplexed optical signal into optical signals of individual wavelengths. If the optical signal is dropped to the client, an optical signal of a predetermined wavelength among the optical signals separated in the demultiplexer 12 should be delivered to the client. If the optical signal is added, the optical signal delivered from the client should be supplied to the optical attenuation control portion 13 without passing through the demultiplexer 12.

The optical attenuation control portion 13 performs the optical attenuation control so that the optical signal levels (intensities) of individual wavelengths become a constant value. In the present embodiment, the optical attenuation control portion 13 is provided with a VAT control portion 21, an adjusting portion 22, a calculating portion 23 and a level monitor 24. Note that the optical attenuation control portion 13 is provided for performing the process for separated optical signals of individual wavelengths independently. However, it is possible to adopt another structure in which the entire of them are regarded as the optical attenuation control portion 13, and the optical signals of individual wavelengths are processed independently inside the optical attenuation control portion 13.

The VAT control portion 21 performs the optical attenuation control that is primary control in the optical attenuation control portion 13 with respect to the optical signals of individual wavelengths. The VAT control portion 21 performs the optical attenuation control by integral action if the optical signal level is within a set integral level range, while it performs the optical attenuation control by proportional action if the optical signal level is outside the integral level range. When the optical attenuation control by proportional action is performed, a filtering process by using a low pass filter is performed, for example.

The adjusting portion 22 makes the VAT control portion 21 work to stop the optical attenuation control if the optical signal level is within a set stop level range. In this case, for example, if it is decided that the optical signal level is within the set stop level range for a predetermined time period or longer in the stable state, the optical attenuation control is stopped. Alternatively, when the optical signal level matches an optimal level, e.g., a target level, the optical attenuation control is stopped.

The adjusting portion 22 also controls the VAT control portion 21 so that the optical attenuation control is restarted when the optical signal level becomes not within a set level range (restart level range) during the stop state of the optical attenuation control.

The calculating portion 23 calculates whether or not the optical signal level is within the various set level ranges.

The level monitor 24 detects the optical signal level delivered by the VAT control portion 21 and delivers the detected level to the calculating portion 23.

The node position recognizing portion 14 stores the node position information DP received from the operational station OPS so as to recognize a state of its own node ND. Then, it obtains a level range corresponding to a state of the node ND from the level storing portion 15 and sends the obtained level range to the calculating portion 23.

The level storing portion 15 stores various reference levels LV received from the operational station OPS. In response to an inquiry from the node position recognizing portion 14, it delivers a level or a level range that meets the condition among the stored various reference levels LV.

The multiplexer 16 combines the optical signals of individual wavelengths after the optical attenuation control in the optical attenuation control portion 13 and multiplexes them.

The amplifier 17 amplifies the optical signal delivered from the multiplexer 16 and delivers it to the line KS.

Although the optical wavelength multiplex transmission apparatus 3 has the above-mentioned structure, it is possible to change the structure in accordance with a position of the node ND. For example, if the input optical signals are all optical signals from the client, the demultiplexer 12 is not necessary. In addition, if the output optical signals are all sent to the client, the multiplexer 16 is not necessary.

The optical wavelength multiplex transmission apparatus 3 can be realized by software when an appropriate program stored in a memory is performed by a CPU, a DSP or the like, or by a hardware circuit using appropriate hardware or by a combination of them.

Next, the optical attenuation control according to the present embodiment will be described more in detail with reference to FIGS. 3 to 9.

In the optical attenuation control of the present embodiment, a filtering process using a low pass filter, an integral process or a stop process is performed in accordance with the optical signal level.

As shown in FIG. 3, a level (LVt) or a level range (LVa-LVc) delivered from the node position recognizing portion 14 and the optical signal level detected by the level monitor 24 are supplied to a subtracter of the calculating portion 23, so that a difference between them is calculated and is amplified by the amplifier. The adjusting portion 22 performs one of the processes based on a value of the difference.

The filtering process by the low pass filter is performed if the optical signal level is deviated from the target level LVt largely, as a process for making it close to the target level LVt rapidly by proportional control. In the present embodiment, the filtering process is performed if the optical signal level is outside the integral level range LVc after the power is turned on or in other timing as shown in FIG. 4. In addition, after the filtering process is once started, the integral process is started when the optical signal level enters the restart level range LVb. In the filtering process, a steady-state error remains although a response speed is high.

In the integral process, a process is performed such that the optical signal level can match the target level LVt exactly when the former approaches the latter substantially. In the present embodiment, if the optical signal level is outside the restart level range LVb after the stop process or if it enters the restart level range LVb in the filtering process, the integral process starts. In addition, after the integral process is once started, the filtering process starts when the optical signal level is outside the integral level range LVc while the stop process starts when it enters the stop level range LVa. In the integral process, the steady-state error does not remain although the response speed is slow.

In the stop process, the optical attenuation control is stopped if the optical signal level is within the stop level range as described above concerning the adjusting portion 22. In this case, for example, if it is decided that the optical signal level is within the set stop level range LVa for a predetermined time period or longer in the stable state, the optical attenuation control is stopped. In addition, if the optical signal level matches an optimal level, e.g., the target level LVt, the optical attenuation control is stopped. Furthermore, during the stop state of the optical attenuation control, the integral process is started if the optical signal level is outside the restart level range LVb, while the filtering process is started promptly if it is outside the integral level range LVc.

As shown in FIG. 5, the level storing portion 15 stores values of levels of “through” and “before drop” as the node position information DP with respect to three types of the reference levels LVa-LVc as patterns. Here, “before drop” of the node position information DP means that the drop is performed in the next node ND of the current node ND. In addition, “through” of the node position information DP means that the drop is not performed in the next node ND.

According to FIG. 5, a standard of the level range is stricter in the case of “before drop” than in the case of “through”. This is because that it is necessary to manage the optical signal level much stricter in the node ND if the drop is performed in the next node ND.

Therefore, for example, the filtering process is performed in the state where the optical signal level is deviated largely in the “before drop”. If it is within the range of “±1.0 dB” with respect to “−20 bBm” that is the target level LVt, the integral process starts. If it is further within the range of “±0.5 dB”, the stop process is started. Furthermore, in the stop state of the optical attenuation control by the stop process, if the optical signal level is outside the range of “±1.0 dB”, the integral process is started. If it is further outside the range of “±1.5 dB”, the filtering process is started.

In FIG. 6, since the optical signal enters the restart level range LVb at the time point t1, the filtering process is switched to the integral process. Then, since it enters the stop level range LVa at the time point t2, the stop process starts. In the stop process, since the state in the stop level range LVa continues for the time period T1 or longer, the optical attenuation control is stopped at the time point t3 when it matches the target level LVt for the first time after that.

Note that it is possible to perform the integral process on the optical signal so that it approaches the target level LVt in the stop process until the stop is actually executed.

After the optical attenuation control is performed, the optical signal level depends on the optical signal level or the like that is supplied to the node ND. For example, if the optical signal that is supplied to the node ND has fluctuations of predetermined amplitude, the fluctuations appear as they are in the output of the node ND.

In FIG. 7, since the optical signal level is outside the restart level range LVb at the time point t4 during the optical attenuation control is stopped by the stop process, the optical attenuation control by the integral process is restarted. In addition, since it is outside the integral level range LVc at the time point t5 after that, the optical attenuation control is switched to the filtering process.

In addition, although it is not shown in the drawing, if it enters the stop level range LVa after the time point t5, the stop process is started again.

Thus, in the optical wavelength multiplex transmission apparatus 3, the optical attenuation control is stopped at the optimal timing if the optical signal level enters the predetermined level range.

In this way, the defect of the conventional optical attenuation control that is accumulation of the fluctuations in the optical signal level is eliminated, and it is able to suppress the accumulation of the fluctuations in the optical signal level even if the nodes ND are connected in a multistage form.

Note that the recognition of the optical signal level and the switching of the processes are performed at an interval of a predetermined short period based on a clock signal or the like or are performed in synchronization with a predetermined short period in FIGS. 6 and 7.

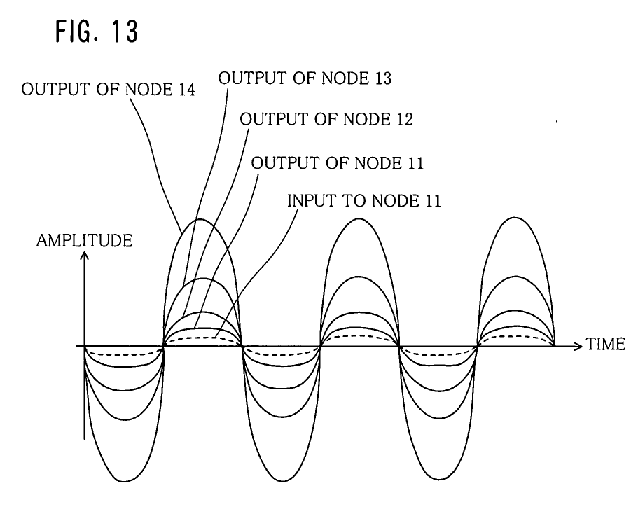

As shown in FIG. 8, if the optical signal level supplied to the node ND1 is in a range that is sufficiently smaller than “±1.0 dB” that is the stop level range LVa, the nodes ND1-ND4 perform the stop process. Thus, only fluctuations having the same amplitude appear in the outputs of the nodes ND1-ND4, so that the fluctuations are not accumulated unlike the conventional structure shown in FIG. 13.

Next, the process operation of the optical wavelength multiplex transmission apparatus 3 according to the present embodiment will be described with reference to flowcharts.

In FIG. 9, the node position recognizing portion 14 of each node ND receives the node position information DP that is set by a maintenance person of the operational station OPS (#11). In the present embodiment, the maintenance person sets “through” to the nodes ND1-ND3 and sets “before drop” to the node ND4.

The node position recognizing portion 14 recognizes a level range to be a target from the level storing portion 15 based on the node position information DP set by the operational station OPS (#12). The node position recognizing portion 14 informs the calculating portion 23 of the level range to be a target (#13).

The calculating portion 23 performs comparing operation between the level range to be a target and the optical signal level obtained from the level monitor 24 (#14). The result of the comparing operation in the calculating portion 23 is sent to the adjusting portion 22 (#15).

The adjusting portion 22 performs control of the VAT control portion 21 based on the result of the comparing operation so as to perform the optical attenuation control or to stop the control or to restart the control (#16).

In FIG. 10, it is decided in the stop process whether or not the optical signal level is within the stop level range LVa (#21). If it is within the stop level range LVa, passing of a time period T1 is waited for deciding a stable state (#22). After the time period T1 passed, when the optical signal level matches the target level LVt (Yes in #23), the stop process is performed (#25). If a time period T2 passed before the optical signal level matches the target level LVt (Yes in #24), the step #21 is performed from the beginning again.

According to the embodiment described above, fluctuations in the optical signal level are not accumulated. The time until the optical signal level becomes stable by the optical attenuation control is shortened, and the number of nodes that can be connected can be increased from the conventional structure.

In the embodiment described above, the node position recognizing portion 14 corresponds to the first level range obtaining portion of the present invention. The level storing portion 15 corresponds to the optical signal level storing portion of the present invention. The adjusting portion 22 and the calculating portion 23 correspond to the optical attenuation control stopping portion of the present invention. In addition, the stop level range LVa corresponds to the first level range of the present invention. The restart level range LVb corresponds to the second level range of the present invention. The integral level range LVc corresponds to the third level range of the present invention.

In the embodiment described above, the structure of the optical wavelength multiplex transmission apparatus 3 can be modified variously from the structure described above. It is possible to use a general feedback control in the optical attenuation control portion 13 as the process for making the optical signal level approach the target level LVt. In this case, it is possible to combine the proportional control, the integral control and the derivative control variously.

In addition, although the condition for switching from the stop process to the integral process and the condition for switching from the filtering process to the integral process are the same restart level range LVb in the above description, it is possible to use different level ranges for them. Although the stop process is performed when the optical signal level matches the target level LVt after it enters the stop level range LVa in the stop process in the above description, it is possible to perform the stop process when it enters the stop level range LVa. In addition, although the optical attenuation control is stopped completely in the stop process, it is possible to make the state where the optical attenuation control is stopped substantially without stopping it completely. It is possible to set various values instead of the above-mentioned values as the stop level range LVa, the restart level range LVb, the integral level range LVc and the like. In addition, it is possible to adopt various methods for comparing the optical signal level with the level range, or for deciding great or small between them.

Other than that, the configuration, the structure, the shape, the number of the entire or each portion of the optical wavelength multiplex transmission apparatus 3 and the WDM system 1, the contents or the order of the processes can be modified if necessary in accordance with the spirit of the present invention.

Although the embodiments of the present invention are described with reference to some example, the present invention can be embodied variously without limiting to the above-mentioned embodiments.

What is claimed is:

1. A control method of an optical wavelength multiplex transmission apparatus that performs an optical attenuation control so that a level of an optical signal becomes constant in each wavelength-multiplexed wavelength, the method comprising the steps of:
deciding whether or not each level of optical signal of each wavelength is within a predetermined first level range; and
if its level is within the first level range, stopping the optical attenuation control for an optical signal of a wavelength having the level.

2. The control method according to claim 1, further comprising the steps of
deciding whether or not the level of the optical signal of the wavelength for which the optical attenuation control is stopped is within a predetermined second level range; and
restarting the optical attenuation control of the optical signal if its level is not within the second level range.

3. An optical wavelength multiplex transmission apparatus comprising:
a demultiplexer that divides a wavelength-multiplexed optical signal into optical signals of individual wavelengths;
an optical attenuation control portion that performs an optical attenuation control so that levels of the optical signals of individual wavelengths become constant;
a multiplexer that combines the optical signals of individual wavelengths after the optical attenuation control and multiplexes them;
an optical signal level storing portion that stores a first level range of optical signal levels; and
an optical attenuation control stopping portion that decides whether or not a level of each of the optical signals of individual wavelengths is within the first level range obtained from the optical signal level storing portion, and if its level is within the first level range, stops the optical attenuation control for an optical signal of a wavelength having the range.

4. The optical wavelength multiplex transmission apparatus according to claim 3, wherein
the optical signal level storing portion stores a plurality of first level ranges in accordance with a node position of the optical wavelength multiplex transmission apparatus in a network, and
the optical attenuation control stopping portion performs the decision by using the first level range that is obtained in correspondence to a node position of the optical wavelength multiplex transmission apparatus among the plurality of first level ranges stored in the optical signal level storing portion.

5. The optical wavelength multiplex transmission apparatus according to claim 3, wherein the optical attenuation control stopping portion stops the optical attenuation control when the optical signal level matches an optimal level within the first level range, if the optical signal level is within the first level range for a predetermined time period or longer.

6. The optical wavelength multiplex transmission apparatus according to any one of claims 3, wherein the optical attenuation control portion performs the optical attenuation control of the optical signal by an integral action if a level of the optical signal of the wavelength is within a third level range that is larger than the first level range, and performs the optical attenuation control of the optical signal by a proportional action if a level of the optical signal of the wavelength is outside the third level range.

7. The optical wavelength multiplex transmission apparatus according to claim 6, wherein the optical attenuation control portion performs filtering of the optical signal by using a low pass filter when it performs the optical attenuation control of the optical signal by the proportional action.

8. The optical wavelength multiplex transmission apparatus according to any one of claims 3 to 7, wherein the optical attenuation control stopping portion restarts the optical attenuation control of the optical signal of the wavelength for which the optical attenuation control is stopped if its level is not within the second level range.

9. An optical wavelength multiplex transmission system in which an optical wavelength multiplex transmission apparatus is disposed at a node of a network, the optical wavelength multiplex transmission apparatus comprising:
a demultiplexer that divides a wavelength-multiplexed optical signal into optical signals of individual wavelengths;
an optical attenuation control portion that performs an optical attenuation control so that levels of the optical signals of individual wavelengths become constant;
a multiplexer that combines the optical signals of individual wavelengths after the optical attenuation control and multiplexes them;
an optical signal level storing portion that stores a plurality of first level ranges of optical signal levels in accordance with a function of the optical wavelength multiplex transmission apparatus at a node in the network;
a first level range obtaining portion that obtains a first level range, among the plurality of first level ranges stored in the optical signal level storing portion, which corresponds to an instruction from an operational system that manages the optical wavelength multiplex transmission system; and
an optical attenuation control stopping portion that decides whether or not a level of each of the optical signals of individual wavelengths is within the first level range obtained from the first level range obtaining portion, and if its level is within the first level range, stops the optical attenuation control for an optical signal of a wavelength having the level.
